(19) United States
(12) Patent Application Publication
(10) Pub. No.: US 2026/0238620 A1
(43) Pub. Date: Aug. 13, 2026

(54) METHOD FOR ENCRYPTED TRANSMISSION OF DATA

(71) Applicant: MERCEDES-BENZ GROUP AG, Stuttgart (DE)

(72) Inventor: Peiguo ZOU, Stuttgart (DE)

(21) Appl. No.: 19/103,945

(22) PCT Filed: Jul. 25, 2023
(86) PCT No.: PCT/EP2023/070493

§ 371 Date: Mar. 31, 2026

(30) Foreign Application Priority Data
Aug. 16, 2022 (DE) 10 2022 002 973.1

(51) Int. Cl. H04L 9/40; H04L 9/32

(52) U.S. Cl. CPC H04L 63/0428; H04L 9/3268

(57) ABSTRACT

The invention relates to a method for encrypted transmission (10) of data between end devices (14, 16), wherein before transmitting the data, a verification certificate (Z*) is created and transmitted to the backend (12) and is signed in the backend (12) by a root certificate (Z), the signed verification certificate (Z**) is returned to the second end device (16), the public second digital key of the signed verification certificate (Z**) is transmitted to the first end device (14) and is checked with a public digital key (S2), wherein in the event of verification, an encrypted one-time symmetric session key (S*) is generated, which is transmitted to the second end device (16) and is decrypted by means of the private key of the signed verification certificate (Z**) , wherein the first end device (14) is informed if the verification fails or, in the event of verification, the data is decrypted with the session key (S*).

### BACKGROUND AND SUMMARY OF THE INVENTION

Exemplary embodiments of the invention relate to a method for encrypted transmission of data.

Increasingly, confidential and person-related data is sent back and forth between two or more parties, including technical systems and the subsystems thereof, via IP-based communication and therefore this data has to be protected from interception and manipulation by unauthorized third parties, including hacker attacks. Particularly in embedded systems, highly sensitive data has to be protected from unauthorized access without excessive CPU loads during storage and during transmission, for example, via Scalable Service-Oriented Middleware over IP (SOME/IP).

A vulnerability enabling easy access, for example, to a private key for encrypting and decrypting data can endanger the security of the entire system. If information is exchanged via a public network, then it goes through several switching nodes, the reliability of which can be questionable. Accordingly, the data has to be completely encrypted before or during transmission from the sender and has to be decrypted after receipt by the receiver. Therefore, these parties or end points always have to have a protected and temporarily exchanged key, which allows them to cryptographically decrypt each other's messages, but which however also has to be protected from unauthorized access if the encrypted data is tapped by unauthorized third parties via other security gaps, for example in the cloud.

A method and a chip for cryptographically encrypting data is already disclosed in DE 10 355 865 B4. The method enables cryptographic encryption and decryption of data with a symmetric encryption algorithm according to the flow principle. Similarly, a new cryptographic method is based on this example for the prior art which is realized/implemented in a new chip. The so-called BAPA chip for implementing the method in hardware is a new cryptographic chip supporting the entire field of electronic data communication. However, a disadvantage is the hardware-dependent encryption and processing by this or other chips, which cannot be integrated into each embedded system, particularly when an existing embedded system does not allow any more changes to the hardware and its architecture.

Similarly, an “end-to-end encryption for personal communication nodes” is disclosed in US 2018 0 063 094 A1, this corresponding to an end-to-end encryption of group communications for personal communication nodes. This is provided by implementing a paired encryption process between a pair of end user devices that are members of a communication group. As a result, an end user device shares a group key with the paired end user device. The group key is encrypted again by using a message key created using the paired encryption process. When a transmitting member of the group communicates with members, it generates a stream key and encrypts stream data with the stream key, encrypts the stream key with the group key and then transmits the encrypted stream key and encrypted stream data to group members. The main disadvantage of this is that a communication group has to be registered beforehand in a server with its identity and public keys. For encrypted communication, a secure connection has to be actively produced in advance between a pair of end user devices. The message key is not encrypted and can be accessed accordingly by unauthorized third parties, including hackers.

Additionally, CA 2 703 612 A1 discloses a secure logic communication connection between a secure payment module and a controller for secure communication in a retail environment, which connection is created by cryptographic authentication of devices that process sensitive information in the retail environment.

Exemplary embodiments of the invention are directed to a method for encrypted transmission of data in such a way that the data is particularly well protected.

One aspect of the invention relates to a method for encrypted transmission of data over a network between a first end device transmitting the data and at least one second end device receiving the data. The network and end devices have all the components necessary for transmitting data, whereby communication between the end devices and a backend of the network is enabled. The method comprises several method steps, wherein, in a first method step, generation of a first private digital key and a public second digital key and a root certificate is carried out. The two keys are thus generated corresponding to each other and certified with the root certificate. A root certificate is a certificate undersigned by the certification authority. It serves to validate the validity of all certificates, in this case keys, which have been issued by the certification authority. In particular, the generation is carried out in this case in the backend of the network. In further method steps, firstly, secure storage of the private first digital key is carried out in the backend of the network and generation and storage of a respective key copy of the public second digital key for the respective end devices is carried out. Then two identical public second digital keys are directly generated and transmitted or forwarded to the respective end devices, or these are already preinstalled there, wherein one can also be generated first and subsequently key copies thereof are generated.

In order to further develop the method for encrypted transmission of data in such a way that the data is particularly well protected, it is provided according to the invention that a verification certificate is created by means of the second end device, specifically the receiver end device, before the transmission of data between the first end device, as a sender, and the second end device, as a receiver, and the verification certificate is transmitted to the backend and is signed in the backend by the root certificate. Subsequently, the signed verification certificate is returned to the second end device, the public second digital key of the signed verification certificate is transmitted to the first end device or to the sender end device and there is checked with the dedicated key copy of the public second digital key, wherein the encrypted transmission of data is rejected by the first end device or by the sender end device if verifications fails. In contrast, in the event of verification, a one-time symmetric session key encrypted with the key copy of the public second digital key of the signed verification certificate is generated, by means of which the data to be transmitted is encrypted. Subsequently, the encrypted session key, and the data encrypted with it, are transmitted to the second end device, specifically the receiver end device, and decrypted there by means of the dedicated private first digital key of the verification certificate, wherein the first end device, specifically the sender end device, is informed if verification fails or, in the event of verification, the data is decrypted with the session key. Thus, transmission of data, particularly protected against unauthorized third parties, including hackers, is afforded by means of session keys and the verification certificates.

In other words, an embodiment of a method for hybrid end-to-end (E2E) encryption, for authentication and for authorization of highly sensitive communications between two or more parties, including technical systems, in particular for embedded systems, is provided.

In this case, first the root certificate with the private and public key for a system composed of end devices and a network with a backend provided with this method is generated. The private first digital key is stored and protected in the common backend. The public key is initially stored in each of the end devices or is preinstalled, for example in ECUs without a backend connection. When an end device wants to send highly sensitive data to another end device “push” or is requested to do so by another end device “pull”, it requests “push” or receives “pull” a one-time verification certificate with the public key from the receiver end device, which is signed with the root certificate via the backend. Additionally, the signature and validity period of the verification certificate are checked with the public key of the root certificate from the sender end device. Further steps of the method are initiated if they match and thus in the event of verification, otherwise transmission to the receiver end device is rejected. Furthermore, a one-time symmetric session key is generated, and this encrypts the highly sensitive data which is to be sent, wherein the session key is encrypted with the public key of the verification certificate. Subsequently, the encrypted highly sensitive data and the encrypted session key are transmitted to the receiver end device. Lastly, the receiver end device decrypts the session key with the private first digital key of the verification certificate, wherein further method steps are initiated if a signature and validity period match and the highly sensitive data is decrypted with the session key. If the match fails, the sender end device is informed by means of a signal.

In an advantageous embodiment of the invention, it is provided that the generation of the private first digital key and the public second digital key and the root certificate is triggered by means of a command transmitted to the backend from one of the end devices. This means that the end devices are designed in such a way to transmit this command at any time via an input, so that the transmission of data can be started by a user of the end device. Alternatively, it is similarly possible to enable triggering for generation by commands from other nodes of the server, for example from partially autonomous or autonomous end devices.

Further advantageous is an embodiment of the invention in which the public second digital key is protected in another memory external to the network. For example, the public second digital key generated in the process and transmitted to the respective end devices can be transmitted to a memory coupled with the end device, whereby the key is not lost if the end device is defective. In particular, storing keys in memories external to the network makes it possible to secure the key and avoid generating a new key, whereby for example using a working memory in the method is at least partially reduced.

In a further advantageous embodiment of the invention, it is provided that the private first digital key is stored protected in a memory external to the network. Due to the external storage, the data, which is stored in the backend, also remains protected in another memory. This is advantageous in particular when using third-party network providers, since the memory external to the network can be switched off, for example, by the OEM and thus a backup of the key is possible and can only be provided by the OEM.

In a further advantageous embodiment of the invention, it is provided that the public second digital key is initially stored in each of the end devices. Therefore, not only is generation avoided, but the single key is only assigned to this one end device, whereby, for example, a simplified and still secure encryption is provided by cryptographic processes that have already been carried out, without a working memory having to be provided for new keys. The public second digital key is initially stored in each of the end devices or is preinstalled, for example, in ECUs without a backend connection. The root certificate can be initiated for a longer time period, for example over twenty years, and renewed as needed.

Similarly advantageous is an embodiment of the invention in which successive failed verifications are counted with a counter. In this case, a counter is then to be triggered whenever the verification fails for various reasons. It is possible to classify the reasons into classes and to save data about the failures for statistical evaluations and improvements. Similarly, it is possible to incorporate different counters into the method in order to collect different data and information.

Similarly, a further embodiment of the invention is advantageous, in which at least one warning signal is triggered for a counter with a count above a specified value. In particular, attempts to log in by third parties and hacker attacks are to be recognized immediately and are forwarded to the network. Therefore, possible unauthorized interference can be blocked immediately so that transmission does not take place.

In further advantageous embodiments of the invention, it is provided that a validity period of the verification certificate or the signed verification certificate is specified, and the encrypted transmission is limited in time. If a backend connection to the backend is successful and the communication takes place over a public network, the validity period of the verification certificate is in particular significantly reduced, depending on use, to one day or even to two hours, in order to avoid unauthorized interception of data by hackers, for example. The time limit of the method also enables a time period for transmitting the data which is then interrupted after expiration of a specified time. This leads to unauthorized interference with the transmission being avoided.

Particularly advantageous is:
It is ensured via the root certificate and the verification certificate (authenticated and authorized) that the sender end device only transmits highly sensitive data if the signature and validity period of the verification certificate are successfully verified with the root certificate, i.e., originate from an authorized end device.
It is ensured via the verification certificate generated for the current communication session (authenticated) that the highly sensitive data is encrypted and decrypted with a session key protected by the verification certificate.
The symmetric session key encrypted or decrypted with the asymmetric verification key can encrypt or decrypt the highly sensitive data without a massive CPU load in the embedded systems.
Also if an end device or component, for example ECU in embedded systems without a backend connection, is to send highly sensitive data in a protected manner to another end device, this can also happen without a backend connection; however, the previous verification certificate that is still valid must be used, which is possible in a protected embedded system having a longer validity period.
If the backend connection is successful and the communication takes place over a public network, the validity period of the verification certificate is significantly reduced, depending on use, to one day or even to 2 hours, in order to avoid unauthorized replay by hackers.
Further end devices or components can be inserted more simply into the protected system by their own verification certificate with the common root certificate.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE SOLE DRAWING FIGURE

Here, the sole drawing FIGURE shows a picture diagram to illustrate a possible example of the method according to the invention for encrypted transmission 10 of data, in particular by means of a hybrid end-to-end encryption (E2EE) and authentication.

A network having a backend 12, a first end device 14, and a second end device 16 are shown in this example. The backend 12 is accessible to registered end devices, specifically a first and second end device 14, 16. In the example, the first end device 14 is represented as a sender and the second end device 16 is represented as a receiver.

FIG. 1 shows a loop having a request for the method, which begins with an initialization 20, in order to create or generate a root certificate Z (not shown) and a private first digital key S1 (not shown) and a public second digital key S2 (not shown). The public second digital key S2 is copied in such a way that a first key copy K1 and a second key copy K2 are created or generated, in order to pass this on to all end devices 14, 16 and in order to encrypt and secure the authorized transmission of highly sensitive data. Therefore, in an initialization 22, the common root certificate Z is created and the secured private first digital key S1 is generated. This is followed by sending 24 the key copy K1 to the first end device 14 and sending 26 the key copy K2 to the second end device 16.

This is followed by a sequence 28 having an alternative request between the first end device 14 and the second end device 16, in which a request 30 for sending highly sensitive data (pull data) is triggered by the second end device 16. This is followed by a requirement 32 of the public second digital key S2 or the key copy K1 for a verification certificate Z* for sending highly sensitive data (push data) by the first end device 14. Reusing 33 a valid verification certificate Z* in the case of an unavailable backend connection is required, for example in the case of embedded components without a backend connection, in order to be initialized in this case.

Then, generating 34 the verification certificate Z* on the second end device 16 is carried out and subsequently a request 36 is launched at the backend 12 in order to sign the verification certificate Z* with the master certificate, specifically the root certificate Z. After that, returning 38 the signed verification certificate Z** from the backend 12 to the second end device 16 takes place. There is a transmission 40. The second end device 16 transmits the signed public second digital key S2 or the key copy K1 of the signed verification certificate Z** for highly sensitive data back to the first end device 14.

This is followed by steps of the first end device 14:
In a first step 42, the signature and the validity of the signed verification certificate Z** is checked with the public second digital key S2 or with the key copy K1 of the root certificate Z. If the verification is not in order, a stop 46 takes place in which the process is stopped and the receiver, the second end device 16, is informed.
In a second step 44, a random session key, specifically a one-time symmetric session key S*, is generated.
In a third step 48, all highly sensitive data is encrypted with the session key S*.
In a fourth step 50, the session key S* is encrypted with the public second digital key S2 or the key copy K1 of the signed verification certificate Z**.
   Finally, in a fifth step, there is a transmission 52 of the encrypted data and the session key S* from the first end device 14 to the second end device 16 and a corresponding decryption 54. The second end device 16 decrypts the session key S* with the private first digital key S1 of the verification certificate Z*. If this does not work, a stop 58 takes place in which the process is stopped and the sending first end device 14 is informed. Otherwise, decryption 56 takes place, in which the second end device 16 decrypts the highly sensitive data with the session key S*. This completes the method for encrypted transmission of data.

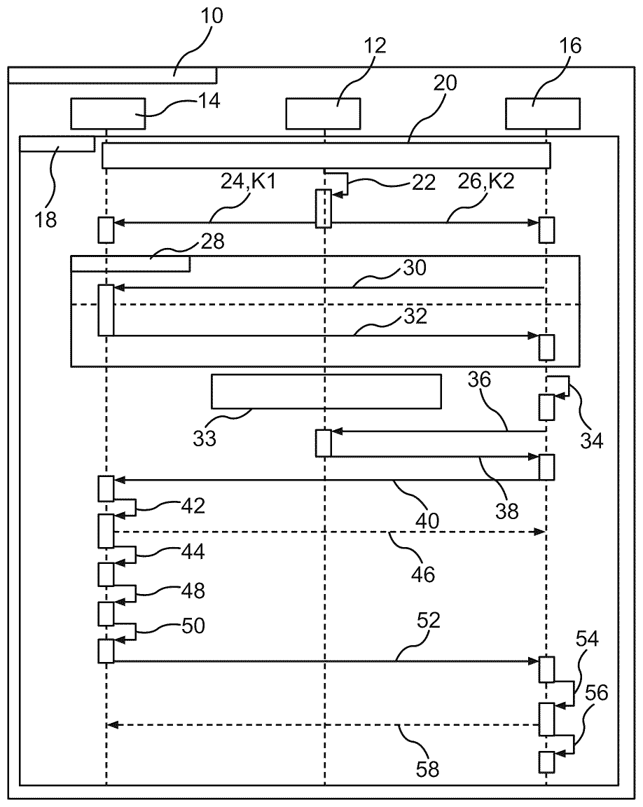

In other words, in FIG. 1, a method is provided for encrypted transmission 10 of data between the end devices 14, 16 over a network, having the method steps:
generating the private first digital key S1 and the public second digital key S2 and the root certificate Z;
securely storing the private first digital key S1 in the backend 12 of the network; and
generating and storing the respective key copy K1, K2 of the public second digital key S2 in the respective end devices 14, 16;

In this case, it is provided that a verification certificate Z* is created before transmitting the data by means of the second end device 16 (receiver end device) and is transmitted to the backend 12 and is signed in the backend 12 by the root certificate Z. Subsequently, the signed verification certificate Z** is transmitted to the first end device 14 and is checked with the dedicated key copy K1 of the public second digital key S2 by the first end device 14 (sender end device), wherein the encrypted transmission of data is rejected if verifications fails or, in the event of verification, a one-time symmetric session key S* encrypted with the key copy K1 of the public second digital key of the signed verification certificate Z** is generated. Additionally, the session key S* is transmitted to the second end device 16 and is decrypted by means of the dedicated private first digital key S1 of the signed verification certificate Z**, wherein the first end device 14 is informed if verification fails or, in the event of verification, the data is decrypted with the session key S*.

It is still possible that the generation of the private first digital key S1 and the public second digital key S2 and the root certificate Z is started by means of a command transmitted to the backend 12 from one of the end devices 14, 16. Similarly, the public second digital key S2 is stored encrypted in a memory external to the network. Furthermore, the private first digital key S1 can be stored encrypted in a memory external to the network. Also, the public second digital key K1 or K2 is initially stored in each of the end devices 14, 16.

Successive failed verifications can be counted with a counter and at least one warning signal is triggered for a counter with a count above a specified value.

Similarly, it is possible that a validity period of the verification certificate Z* or the signed verification certificate Z** is specified, and it is also possible that the encrypted transmission is limited in time.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE SYMBOL LIST

10 Encrypted transmission
12 Backend
14 first device
16 second device
20 initialization
22 initialization
24 Send
26 Send
28 sequence
30 Inquiry
32 Requirement
33 reuse
34 Generation
36 Inquiry
38 Return
40 transmission
42 first step
44 second step
46 stop
48 third step
50 fourth step
52 transmission
54 Decryption
56 Decryption
58 stop
K1 First key copy
K2 Second key copy
S1 first keys
S2 second key
S* Session key

1-10. (canceled)

11. A method for encrypted transmission of data over a network between a first end device transmitting the data and at least one second end device receiving the data, the method comprising:
generating, by the backend, a private first digital key, a public second digital key corresponding to the first private digital key, and a root certificate signed by the backend, wherein the root certificate certifies a validity of the private first digital key and the public second digital key;
securely storing, by the backend, the private first digital key;
generating and storing, by the backend, a first key copy of the public second digital key;
transmitting, by the backend, the first key copy to the first end device;
generating and storing, by the backend, a second key copy of the public second digital key;
transmitting, by the backend, the second key copy to the first end device;
generating, by the second end device and before the first end device transmits the data, a verification certificate;
transmitting, by the second end device and before the first end device transmits the data, the verification certificate to the backend;
signing, by the backend and before the first end device transmits the data, the verification certificate with the root certificate to generate a signed verification certificate;
transmitting, by the backend to the second end device, the signed verification certificate, wherein the signed verification certificate includes the public second digital key;
transmitting, by the second end device to the first end device, the public second digital key of the signed verification certificate;
receiving, by the first end device from the second end device, the public second digital key of the signed verification certificate;
checking, by the first end device, a validity of the public second digital key of the signed verification certificate using the first key copy;
generating, by the first end device responsive to the checking indicating that the public second digital key of the signed verification certificate is valid, a one-time symmetric session key encrypted with the first key copy as an encrypted session key;
transmitting, by the first end device to the second end device, the encrypted session key and data encrypted with the encrypted session key;
decrypting, by the second end device, the transmitted, encrypted session key and data encrypted with the encrypted session key.

12. The method of claim 11, wherein the backend generates the private first digital key, the public second digital key, the root certificate responsive to a command transmitted to the backend from one of the first and second end devices.

13. The method of claim 11, wherein the public second digital key is stored encrypted in a memory external to the network.

14. The method of claim 11, wherein the private first digital key is stored encrypted in a memory external to the network.

15. The method of claim 11, wherein the public second digital key is initially stored in each of the first and second end devices.

16. The method of claim 11, wherein, responsive to a failure of the validity of the public second digital key of the signed verification certificate, successive failed verifications are counted with a counter.

17. The method of claim 16, further comprising:
triggering at least one warning signal when a count of the counter exceeds a specified value.

18. The method of claim 11, wherein the verification certificate includes a validity period.

19. The method of claim 11, wherein the signed verification certificate includes a validity period.

20. The method of claim 11, wherein the encrypted transmission is limited in time.
